(19) United States
(12) Patent Application Publication
(10) Pub. No.: US 2011/0123030 A1
(43) Pub. Date: May 26, 2011

(54) Dynamic spatial audio zones configuration

(75) Inventor: Sachin G. Deshpande, Camas, WA (US)

(73) Assignee: Sharp Laboratories of America, Inc.

(21) Appl. No.: 12/592,506

(22) Filed: Nov. 24, 2009

(51) Int. Cl. H04R 5/00

(52) U.S. Cl. 381/17

(57) ABSTRACT

A method for presenting audio-visual content for a display includes defining a window associated with a program having associated audio signals on the display. An audio position is defined for the audio signals based upon a position of the window on the display, and a position of at least two speakers associated with the display. The audio signals are modified based upon the audio position in such a manner that the audio signals appear to originate from the window.

### CROSS-REFERENCE TO RELATED APPLICATIONS

Not applicable.

### BACKGROUND OF THE INVENTION

The present invention relates generally to providing audio together with a display.

Ambiosonics is a surround sound system where an original performance is captured for replay. The technique for capturing the performance is such that the original surround sound can be recreated relatively well. In some cases, a “full sphere” of surround sound can be reproduced.

The University of California Santa Barbara developed an Allosphere system that includes a 3-story high spherical instrument with hundreds of speakers, tracking systems, and interaction mechanisms. The Allosphere system has spatial resolution of 3 degrees in the horizontal plane, 10 degrees in elevation, and uses 8 rings of loudspeakers with 16-150 loudspeakers per ring.

NHK developed a 22.2 multichannel sound system for ultra high definition television. The purpose was to reproduce an immersive and natural three-dimensional sound field that provides a sense of presence and reality. The 22.2 sound system include an upper layer with nine channels, a middle layer with ten channels, and a lower layer with three channels, and two channels for low frequency effect.

The Ambiosonics, Allosphere, and NHK systems are suitable for reproducing sounds, and may be presented together with video content, so that the user may have a pleasant experience.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a dynamic spatial audio zone system.

FIG. 2 illustrates loudspeaker pair plane and virtual source position calculation.

FIG. 3 illustrates a three dimensional plane defining a loudspeaker pair, a listener, and a circle.

FIG. 4 illustrates an audio-visual window mapping to a loudspeaker pair.

FIG. 5 illustrates mapping of an audio-visual window to a loudspeaker pair.

FIG. 6 illustrates a flowchart of on-screen virtual source position calculation.

FIG. 7 illustrates a flowchart of on-screen virtual source position mapping to actual virtual source position mapping using a normal technique.

FIG. 8 illustrates a three dimensional mapping of an on-screen virtual source position to actual virtual source position using the normal technique of FIG. 7.

FIG. 9 illustrates a flowchart of on-screen virtual source position mapping to actual virtual source position mapping using the technique of a projection.

FIG. 10 illustrates a three dimensional mapping of an on-screen virtual source position and to an actual virtual source position using a projection technique of FIG. 9.

FIG. 11 illustrates a zoomed in part showing the virtual source position and pair of actual virtual source positions.

FIG. 12 illustrates a dynamic spatial audio zones system with four loudspeakers.

### DETAILED DESCRIPTION OF PREFERRED EMBODIMENT

Displays with large screen size and high resolution are increasingly becoming affordable and ubiquitous. These include flat panel LCD and PDP displays, front and rear projection displays, among other types of displays. In a home environment traditionally a display has been utilized to view a single program while viewing audio-visual content. As the display gets larger, it is more feasible to be used simultaneously by multiple users for multiple separate applications. Also, it is more feasible to be used by a single user for multiple simultaneous uses. These applications may include television viewing, networked audio-visual stream viewing, realistic high resolution tele-presence, music and audio applications, single and multi-player games, social applications (e.g. Flickr, Facebook, Twitter, etc.), and interactive multimedia applications. For many of these applications, audio is an integral aspect. Unfortunately, while using multiple applications simultaneously it is difficult to determine the audio to which each is associated with. In addition, for large displays it may be difficult to identify which application the sound originated from.

To provide the ability for the user to correlate the audio sound with the particular source window, it is desirable for the system to modify the audio signals so that the audio appears to originate from a particular window. In the case of multiple active windows on a display, it is desirable for the system to modify the audio signals so that the respective audio appears to originate from the respective window. In some cases, the display is constructed from a plurality of individual displays arranged together to effectively form a single display.

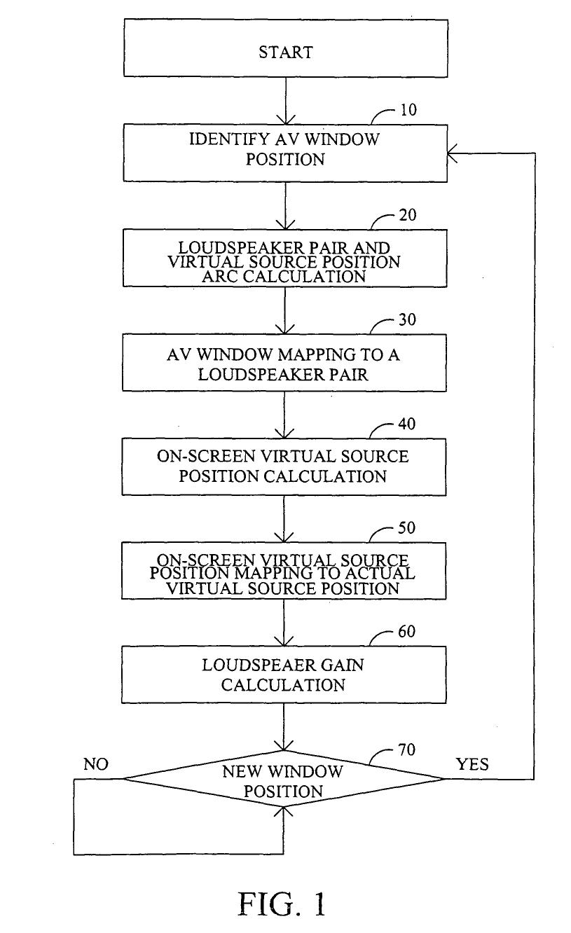

Referring to FIG. 1, a spatial audio zone system may first identify the audio-visual window position(s) 10. Large sized displays (including tiled displays) can concurrently display multiple applications A(i), i=0, 1, . . . , Z−1. Each application has its own window/viewport/area on the display. Each application likewise tends to run in its own window/viewport. For simplicity, the description may consider a single application A(i) which has its window W(i) of C×D horizontal and vertical pixels. However, multiple concurrent windows may likewise be used. The window is placed on the display such that the bottom left corner of the window (in the event of a rectangular window) is at x, y position of (blx,bly) with respect to the overall display. The overall display has (0,0) position on the bottom left corner of the display.

Some of the application windows may be audio-visual program windows. A window may be considered an audio-visual program window if it is associated with an audio signal. Typical examples of the audio-visual windows may include entertainment applications (e.g. video playback), communication applications (e.g. a video conference), informational applications (e.g. an audio calendar notifier), etc.

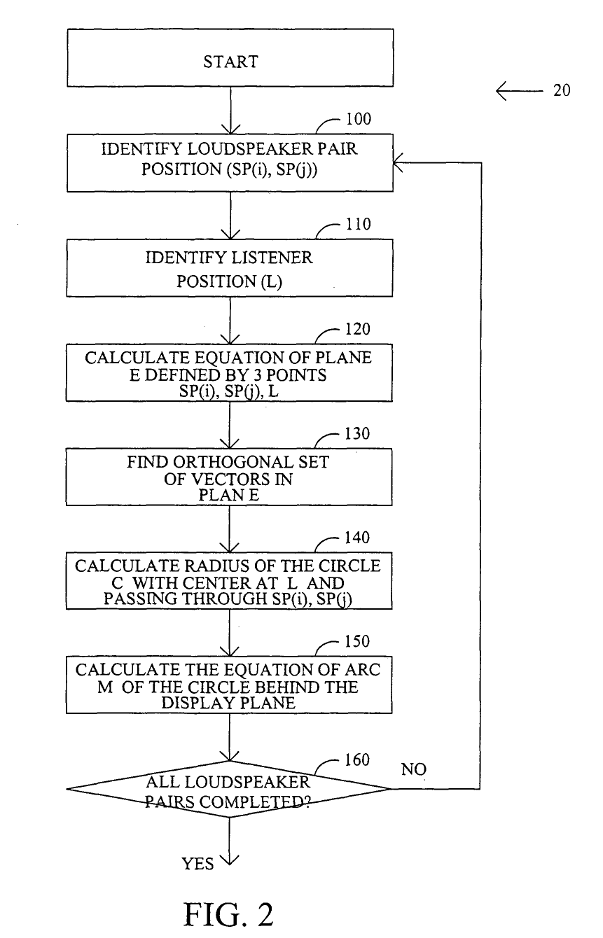

Referring to FIG. 2, after identifying the audio-visual window positions 10, the system may calculate the loudspeaker pair and virtual source position arc 20. In essence, this may calculate the available locations from which sound may appear to originate given the arrangement of the speakers. The following symbols may be defined:

Denote a pair of loudspeakers Sp(i), Sp(j) as P(i,j).

Define position of a loudspeaker 100 Sp(i) to be (Xᵢ,Yᵢ,Zᵢ). In the example, all the loudspeakers Sp(i) may have same Z co-ordinates. This may be denoted to be Zᵢ=Z_{D} for SP(i) ∀i. The vector from origin to a speaker position may be defined as Sp(i) to be \vec{Vₛₚ₍ᵢ₎}.

Define the listener L position 110 to be (X_{L},Y_{L},Z_{L}). Define the vector from origin to listener position to be \vec{V_{L}}.

Then find the equation of the plane 120 E(L, Sp(i), Sp(j))=E(i,j) which may be defined by the points L, Sp(i), Sp(j) as follows:
Let vectors V, and V, be defined as:

\vec{Vᵢ}=\vec{V_{L}}−\vec{Vₛₚ₍ᵢ₎} (a)

\vec{Vⱼ}=\vec{V_{L}}−\vec{Vₛₚ₍ⱼ₎} (b)
Then the normal to the plane is given by:
   {right arrow over (N(E(i,j)))}=\vec{Vᵢ}×\vec{Vⱼ} where x denotes the vector cross product.
Denote the normal vector 130 {right arrow over (N(E(i,j)))} by co-ordinates (X_{Lij},Y_{Lij},Z_{Lij}).
Then the equation of the 3D plane (E(i,j)) defined by points L, Sp(i), Sp(j) is:

X_{Lij}(x−X_{L})+Y_{Lij}(y−Y_{L})+Z_{Lij}(z−Z_{L})=0.

The circle in the three dimensional plane 140 E(i,j) with center at (X_{L},Y_{L},Z_{L}) and passing through points Sp(i), Sp(j) may be defined by following equations:
Vectors \vec{Vᵢ} and \vec{Vⱼ} may be defined as above.
The Gram-Schmidt process may be applied to find the orthogonal set of vectors, \vec{Uᵢ}, \vec{Uⱼ} in E(i,j) plane as follows:

\vec{Uᵢ}=\vec{Vᵢ}

$${\vec{U}}_{j} = {\vec{V}}_{i} - < {\vec{U}}_{i} , {\vec{V}}_{j} > \frac{{\vec{U}}_{i}}{< \vec{{U}_{i}} , \vec{{U}_{i}} >}$$

where <\vec{Uᵢ},\vec{Vⱼ}> represents the inner product of vectors \vec{Uᵢ} and \vec{Vⱼ}.
Then the radius of the circle is given by: R(\vec{Vₛₚ₍ᵢ₎},\vec{Vₛₚ₍ⱼ₎})=R(i,j)=\sqrt{\vec{Vᵢ}.\vec{Vᵢ}}, where \vec{Vᵢ}.\vec{Vᵢ} indicates the dot product of vector \vec{Vᵢ} with vector \vec{Vᵢ}.
The equation of the circle 150 M(L,sp(i),sp(j))=M(i,j) in parametric form is given by:

M(L,sp(i),sp(j))=R(i,j)Cos(t)\vec{Vᵢ}+R(i,j)Sin(t)\vec{Vⱼ}+\vec{V_{L}}.

This process may be repeated 160 for all the pairs of loudspeakers that are associated with the display. It is to be understood that this technique may be extended to three or more loudspeakers.

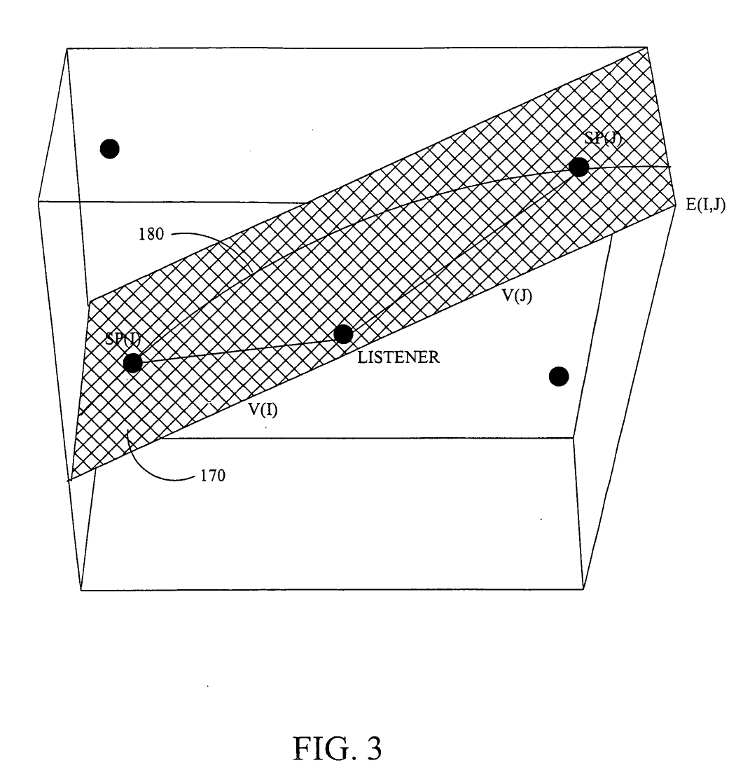

Referring to FIG. 3, the three dimensional plane E(i,j) 170 and the arc of circle M(i,j) 180 is illustrated. As it may be shown, for a pair of speakers, and arc between the two speakers in an arc around the listener is determined. It is along this arc that audio sounds may appear to originate to the listener based upon the particular pair of speakers.

Referring again to FIG. 1, based upon the loudspeaker pair and virtual source 20, an audio-visual window on the display is mapped to loudspeaker pairs 30. In essence, this determines the spatial relationship between the arc defined by the speaker pairs and the on-screen window on the display for the audio. Preferably, the arc of the loudspeaker pair that is closest to the location of the window is the pair of speakers selected to provide the audio signal.

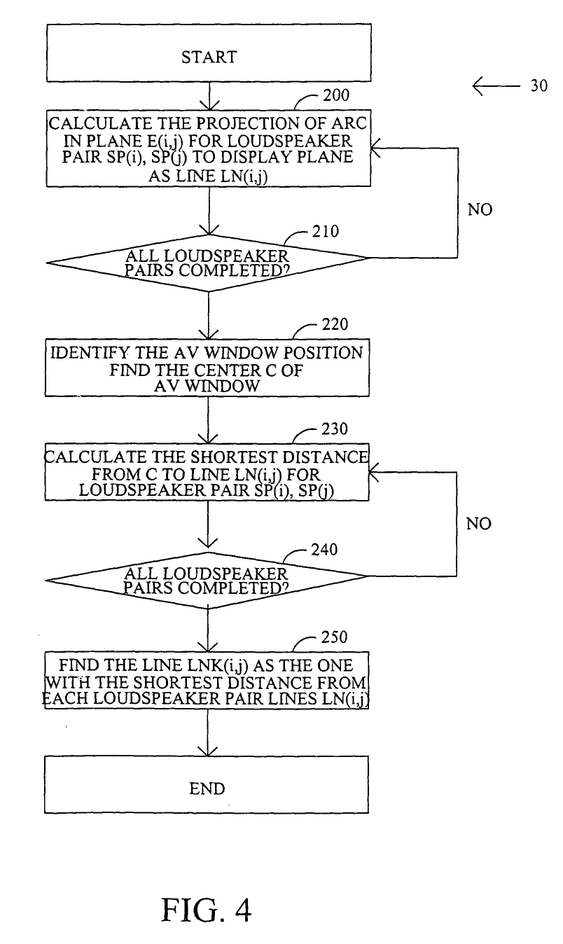

Referring to FIG. 4, the mapping technique is illustrated.

Let the line formed in the display plane, by the projection 200 of the arc of the circle in the 3D plane defined by L, Sp(i), Sp(j) be denoted by Ln(i,j). Line for a loudspeaker pair may overlap with a line from another loudspeaker pair. In case of overlapping lines, the longest line is used. In other embodiment multiple short lines may be used instead of the longest line.

This process 210 is repeated for all the loudspeaker pairs. The set of such lines formed by each pair of loudspeakers may be denoted as SLn={Ln(1,2), Ln(2,3), . . . }.

A window W(k) for the application may be A(k). The center 220 of the window W(k) may be defined as C(k).
Let the Center C(k) be denoted by the points (X(k),Y(k),Z_{D}). The center point can be calculated based on the window W(k)'s bottom left corner position (blx,bly) and its horizontal and vertical pixel dimensions C×D as:

$$( {X}_{k} , {Y}_{k} , {Z}_{D} ) = ( blx + \frac{C}{2} , bly + \frac{D}{2} , {Z}_{D} ) .$$

Then the shortest distance 230 is determined from the center C(k) to each line Ln(i,j). The following steps are taken to find the shortest distance from the center C(k) of window W(k) to a line Ln(i,j):
The line Ln(i,j) is defined by the points (Xᵢ,Yᵢ,Zᵢ) and (Xⱼ,Yⱼ,Zⱼ) which corresponds to loudspeaker positions Sp(i), Sp(j), and has the equation (in display plane):

$$( y - {Y}_{i} ) = \frac{( {Y}_{j} - {Y}_{i} )}{( {X}_{j} - {X}_{i} )} ( x - {X}_{i} )$$

which can be written as

Ax+By+C=0 where

$$A = \frac{- ( {Y}_{j} - {Y}_{i} )}{( {X}_{j} - {X}_{i} )}$$

$$B = 1$$

$$C = - ( {Y}_{i} - \frac{( {Y}_{j} - {Y}_{i} )}{( {X}_{j} - {X}_{i} )} {X}_{i} )$$

Then the perpendicular distance from C(k) to line Ln(i,j) may be given by:

$$D ( C ( k ) , i , j ) = \frac{\vert AX ( k ) + BY ( k ) + C \vert}{\sqrt{{A}^{2} + {B}^{2}}} .$$

This is repeated 240 for all loudspeaker pairs. Then the line 250 from the set SLn which has the shortest distance from the center C(k) may be determined. One may denote this line as Lnₖ(i,j).

Lnₖ(i,j)=min(D(C(k),i,j))∀i,∀j

If more than one line are at the same shortest distance from the center C(k), then any one of those lines may be selected.

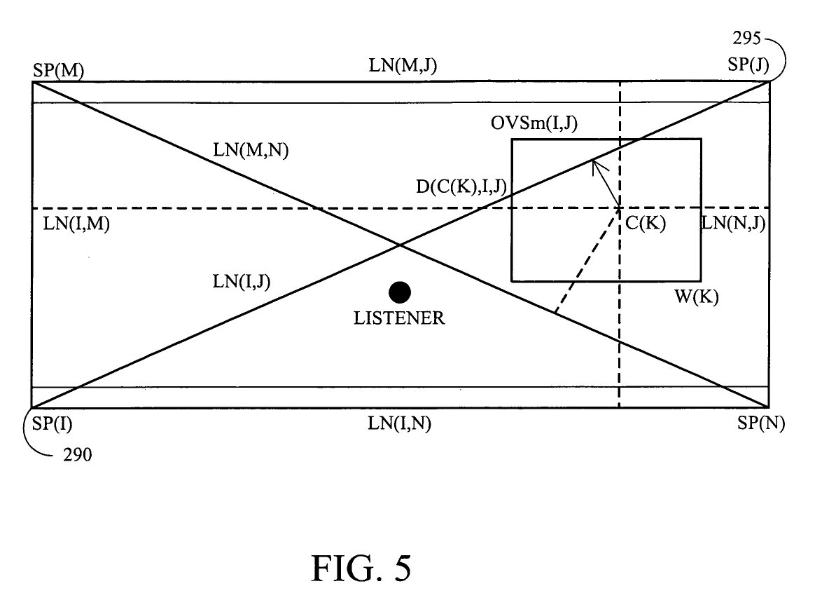

Referring to FIG. 5, the mapping technique of the audio-visual window to a loudspeaker pair is illustrated. The window W(k) 260 for the application A(k) has a window center C(k) 270. The shortest distance for C(k) 270 is from line Ln(i,j) 280. In this particular location, loudspeaker pair Sp(i) 290 and Sp(j) 295 are selected. It is noted that the other loudspeaker pairs are further from C(k).

Referring again to FIG. 1, based upon the audio-visual window mapping to a loudspeaker pair 30, an on-screen virtual source position is calculated 40. In essence, this selects an on-screen source position for the audio. Preferably, the center of the window is selected for the source of the sound, but other locations within or near the window may likewise be selected.

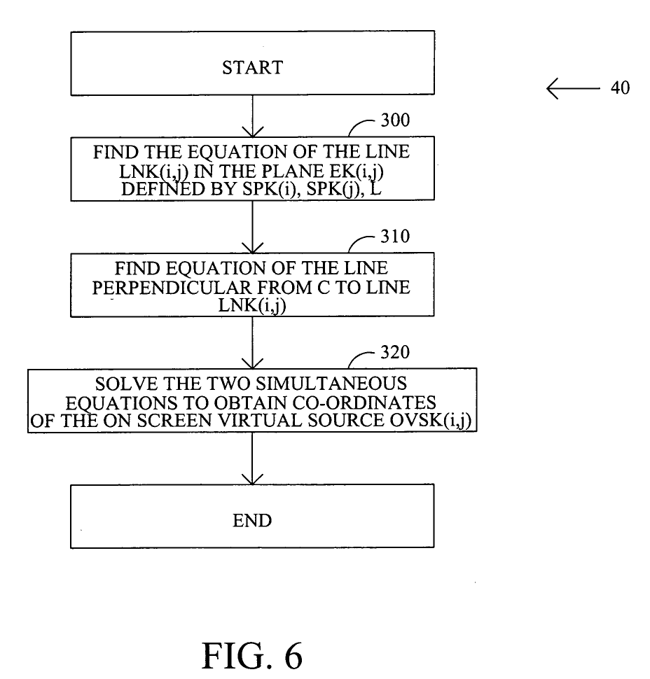

Referring to FIG. 6, the on-screen virtual source position calculation is illustrated.

The point of intersection of the line Lnₖ(i,j) and the perpendicular from C(k) to Lnₖ(i,j) is denoted by OVSₖ(i,j). The point OVSₖ(i,j) is the “On-screen Virtual Source” position for window W(k). One may denote C(k) to be the “Unmapped On-Screen Virtual Source” position for window W(k).

The co-ordinates of point OVSₖ(i,j)=(Xₒ,Yₒ,Z_{D}) may be calculated as follows:
Equation of the line 300 Lnₖ(i,j) in the plane E(Lₖ, Spₖ(i), Spₖ(j))=Eₖ(i,j) may be given by:

Aₖx+Bₖy+Cₖ=0 where

$${A}_{k} = \frac{- ( {Y}_{kj} - {Y}_{ki} )}{( {X}_{kj} - {X}_{ki} )}$$

$${B}_{k} = 1$$

$${C}_{k} = - ( {Y}_{ki} - \frac{( {Y}_{kj} - {Y}_{ki} )}{( {X}_{kj} - {Xk}_{i} )} {X}_{ki} )$$

where Spₖ(i)=(Xₖᵢ,Yₖᵢ,Z_{D}), SPₖ(i)=(Xₖⱼ,Yₖⱼ,Z_{D}).
Equation of the line perpendicular 310 from C(k) to line Lnₖ(i,j) in the plane Eₖ(i,j) may be given by:

$$\frac{{B}_{k}}{{A}_{k}} x - y + ( Y ( k ) - \frac{{B}_{k} X ( k )}{{A}_{k}} ) = 0.$$

Then the co-ordinates of point OVSₖ(i,j)=(Xₒ,Yₒ,Z_{D}) are obtained by solving following pair of equations 320 as simultaneous equations:

$${A}_{k} x + {B}_{k} y + {C}_{k} = 0$$

$$\frac{{B}_{k}}{{A}_{k}} x - y + ( Y ( k ) - \frac{{B}_{k} X ( k )}{{A}_{k}} ) = 0.$$

Which gives the solution:

$${X}_{o} = \frac{( {A}_{k} {C}_{k} + {A}_{k} {B}_{k} Y ( k ) - {B}_{k}^{2} X ( k ) )}{( - {A}_{k}^{2} - {B}_{k}^{2} )}$$

$${Y}_{o} = \frac{( {A}_{k} {B}_{k} X ( k ) - {A}_{k}^{2} Y ( k ) + {C}_{k} {B}_{k} )}{( - {A}_{k}^{2} - {B}_{k}^{2} )} .$$

Referring again to FIG. 1, based upon the on-screen virtual source position 40 an on-screen virtual source position mapping to an actual virtual source position may be calculated 50. In essence, this provides a mapping to where the audio should originate from. Preferably, on-screen source is mapped to the virtual source using a perpendicular or directional manner, or any other suitable technique.

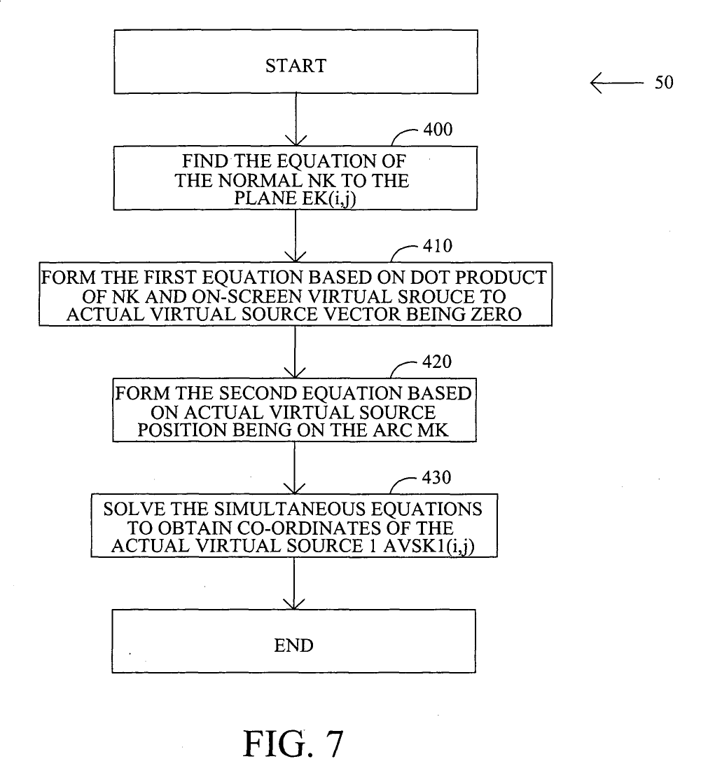

Referring to FIG. 7, the on-screen virtual position mapping to actual virtual source position is illustrated.

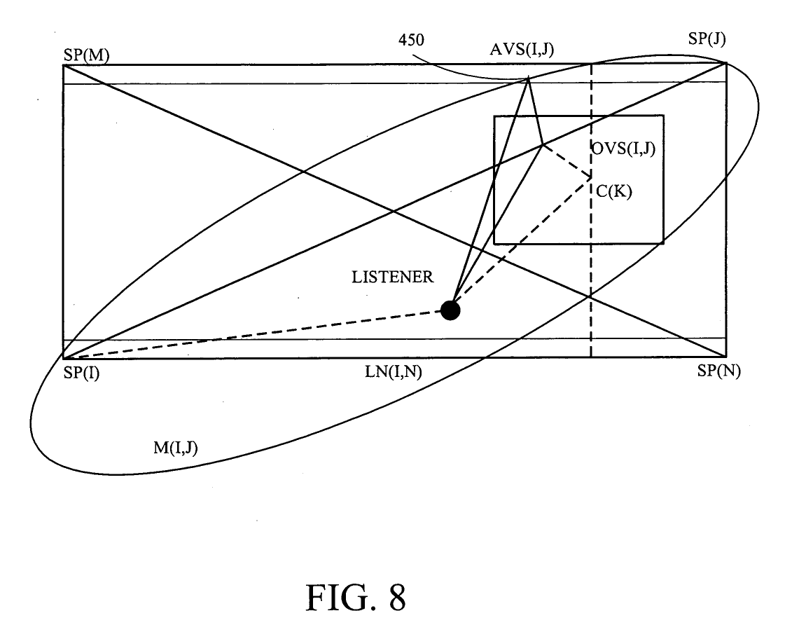

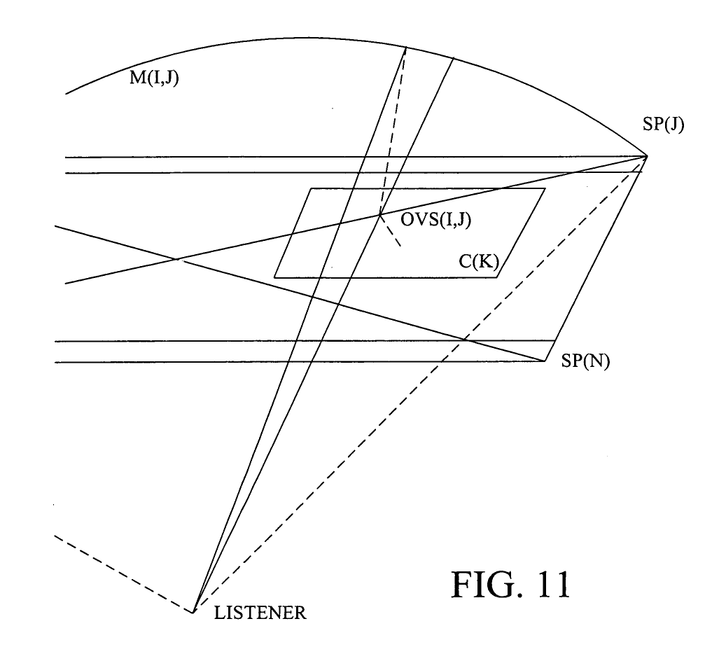

The system maps the on-screen virtual source point OVSₖ(i,j) to the three-dimensional point AVSₖ(i,j) (Actual Virtual Source) on the arc of the circle Mₖ(i,j). One technique for such a mapping is done by projecting the point OVSₖ(i,j) orthogonally to the display plane and finding its intersection with Mₖ(i,j). (see FIG. 8, FIG. 11).

The co-ordinates of this point AVSₖ₁(i,j) can be found by obtaining the intersection of the line Q(i,j) perpendicular to the plane Z=Z_{D} and passing through point OVSₖ(i,j)=(Xₒ,Yₒ,Z_{D}) with the circle Mₖ(i,j):
Define AVSₖ₁(i,j)=(Xₐ,Yₐ,Zₐ).
The co-ordinates of point (Xₐ,Yₐ,Zₐ) can be obtained by solving the following pair of equations to obtain Yₐ,Zₐ:
   The normal to the plane E(Lₖ, Spₖ(i), Spₖ(j))=Eₖ(i,j) is {right arrow over (N(Eₖ(i,j)))} defined by co-ordinates (X_{Lij}^{k},Y_{Lij}^{k},Z_{Lij}^{k}):
   Define the vector joining listener position with AVSₖ₁(i,j) as \vec{V_{L,AVS}_{ₖ₁}}. Then the dot product of {right arrow over (N(Eₖ(i,j)))} with V_{L,AVS}_{ₖ₁} may be zero.
   Thus {right arrow over (N(Eₖ(i,j)).)}\vec{V_{L,AVS}_{ₖ₁}}=0, i.e.

X_{Lij}^{k}(Xₒ−X_{L})+Y_{Lij}^{k}(Yₐ−Y_{L})+Z_{Lij}^{k}(Zₐ−Z_{L})=0.
Also since the point AVSₖ₁(i,j) lies on the circle Mₖ(i,j), it satisfies:

\sqrt{(Xₒ−X_{L})²+(Yₐ−Y_{L})²+(Zₐ−Z_{L})²}=R(i,j).
Define:

(Xₒ−X_{L})=X_{oL}

(Yₐ−Y_{L})=Y_{aL}.

(Zₐ−Z_{L})=Z_{aL}

Then solving the above pair of equations for Yₐ,Zₐ gives following solution:

$${Y}_{a} = {Y}_{L} + \frac{1}{{Y}_{Lij}^{k}} \{ \frac{\begin{matrix}- {X}_{Lij}^{k} {X}_{oL} + \frac{{X}_{Lij}^{k} {{X}_{oL} ( {Z}_{Lij}^{k} )}^{2}}{{( {Y}_{Lij}^{k} )}^{2} + {( {Z}_{Lij}^{k} )}^{2}} - \\ {Z}_{Lij}^{k} \sqrt{\begin{matrix}4 {( {X}_{Lij}^{k} {Z}_{Lij}^{k} {X}_{oL} )}^{2} - 4 ( {( {X}_{Lij}^{k} {X}_{oL} )}^{2} - \\ ( R ( i , j ) - {X}_{oL}^{3 / 2} ) \\ {( {Y}_{Lij}^{k} )}^{2} ) ( {( {Y}_{Lij}^{k} )}^{2} + {( {Z}_{Lij}^{k} )}^{2} )\end{matrix}}\end{matrix}}{2 ( {( {Y}_{Lij}^{k} )}^{2} + {( {Z}_{Lij}^{k} )}^{2} )} \}$$

$${Z}_{a} = \begin{matrix}{Z}_{L} + \frac{1}{2 ( {( {Y}_{Lij}^{k} )}^{2} + {( {Z}_{Lij}^{k} )}^{2} )} \\ \{ - 2 {X}_{Lij}^{k} {X}_{oL} {Z}_{Lij}^{k} ++ \sqrt{\begin{matrix}4 {( {X}_{Lij}^{k} {Z}_{Lij}^{k} {X}_{oL} )}^{2} - 4 ( {( {X}_{Lij}^{k} {X}_{oL} )}^{2} - \\ ( R ( i , j ) - {X}_{oL}^{3 / 2} ) \\ {( {Y}_{Lij}^{k} )}^{2} ) ( {( {Y}_{Lij}^{k} )}^{2} + {( {Z}_{Lij}^{k} )}^{2} )\end{matrix}} \}\end{matrix} .$$

Referring to FIG. 8, the mapping of the on-screen virtual source position 440 to an actual virtual source position 450 is illustrated.

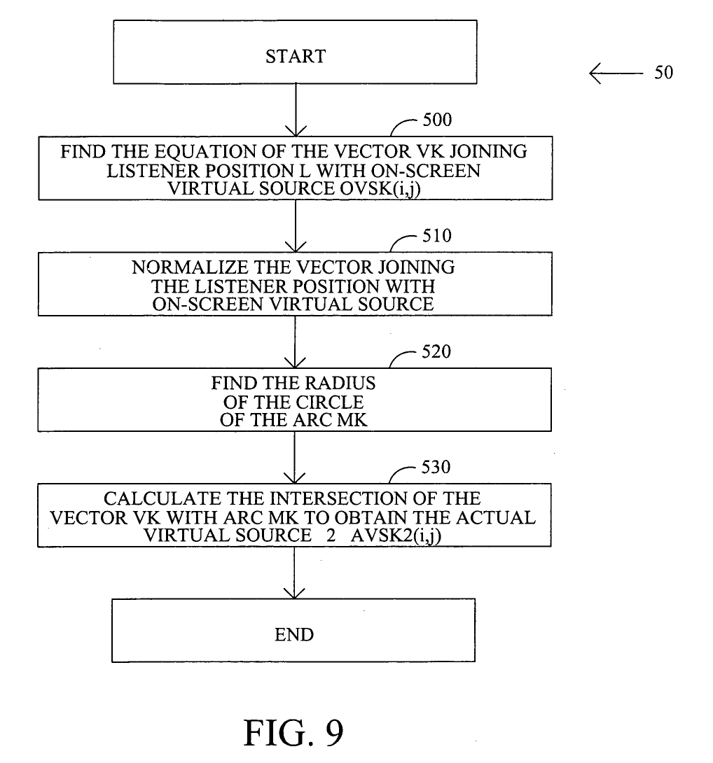

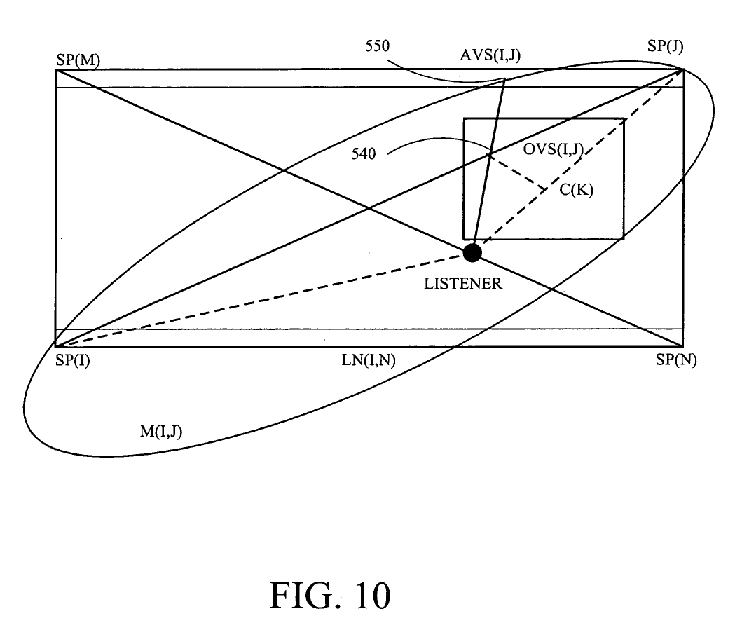

Referring to FIG. 9, another on-screen virtual position mapping to actual virtual source position is illustrated. The system maps the on-screen virtual source point OVSₖ(i,j) to the three-dimensional point AVSₖ(i,j) (Actual Virtual Source) on the arc of the circle Mₖ(i,j). The technique for such a mapping is done by projecting the point OVSₖ(i,j) along the line defined by points (L,OVSₖ(i,j)) and finding its intersection with Mₖ(i,j). (see FIG. 10, FIG. 11).

The co-ordinates of this point AVSₖ₂(i,j) can be found by obtaining the intersection 530 of the line T(i,j) passing through the points (X_{L},Y_{L},Z_{L}) and the point OVSₖ(i,j)=(Xₒ,Yₒ,Z_{D}) with the circle Mₖ(i,j) 520. This can be calculated as follows:

Let use define AVSₖ₂(i,j)=(Xₐ,Y_{b},Z_{b}).
The vector 500 (X_{L},Y_{L},Z_{L}) to OVSₖ(i,j) is given by:

\vec{V_{L,OVS}_{ₖ}}=(X_{L},Y_{L},Z_{L})−(Xₒ,Yₒ,Z_{D}).
Normalizing 510 the vector obtains:

$${V}_{L , {OVS}_{k}} = \frac{\vec{{V}_{L , {OVS}_{k}}}}{\vert \vec{{V}_{L , {OVS}_{k}}} \vert} .$$

Then AVSₖ₂(i,j)=(X_{L},Y_{L},Z_{L})−R(i,j) [symbol] .

Referring to FIG. 10, the mapping of the on screen virtual source position 540 to the virtual source position 550 is illustrated.

Referring to FIG. 11, an enlarged part of the screen virtual source position OVSₖ(i,j) and two actual virtual source positions (AVSₖ₁(i,j), AVSₖ₂(i,j)) obtained from two different mapping techniques are illustrated. This illustrates slight differences between the orthogonal technique and the projection technique.

Referring again to FIG. 1, based upon the on-screen virtual source position mapping 50 the loudspeaker gain is calculated 60. This may be done using existing approaches for loudspeaker gain calculation for virtual sound positioning. On such known approach is described in B. Bauer, “Phasor Analysis of Some Stereophonic Phenomena,” Journal Acoust. Society of America, Vol. 33, November 1961.

The loudspeaker pair Pₖ(i,j) is used to virtually position the sound source for window W(k) at point AVSₖ(i,j) k=k₁ or k=k₂. In some embodiments, the gain of each loudspeaker Pₖ(i,j) may be further modified to compensate for the distance between OVSₖ(i,j) and AVSₖ(i,j). In some embodiments the mappings between OVSₖ(i,j) and Pₖ(i,j) may be pre-computed and stored in a lookup table. The loudspeaker gains may be selected in any manner.

In an embodiment where a SAGE system is used for a tiled display the dynamic spatial audio zones can be achieved as follows. Lets assume that there is one, rendering node generating the application data including audio data for application A(i). Lets assume that there are M×N display nodes. Thus one display node corresponds to one tile. Then the following steps may be taken to support the spatial audio as described above.

(1) For the window W(k), of C×D pixels at position (blx,bly), the set of tiles that it overlaps with is determined. Lets denote this set as T (o,p) with o and p denoting tile index as described previously. Typically the free space manager of SAGE may do this determination. The center C(k) of window W(k) can be determined from this information.

(2) The rendering node may split the application A(k) image into sub-images. Typically the free space manager may communicate with rendering node to provide the information from the previous step for this.

(3) Create a network connection from rendering node to each of the display nodes D(o,p),∀o,p, where the application window may overlap.

(4) Stream the audio for application A(k) to each of the display nodes D(o,p),∀o,p.

(5) Playback the audio from audio reproduction devices Spₖ(i), Spₖ(j) with mappings and other steps as described above.

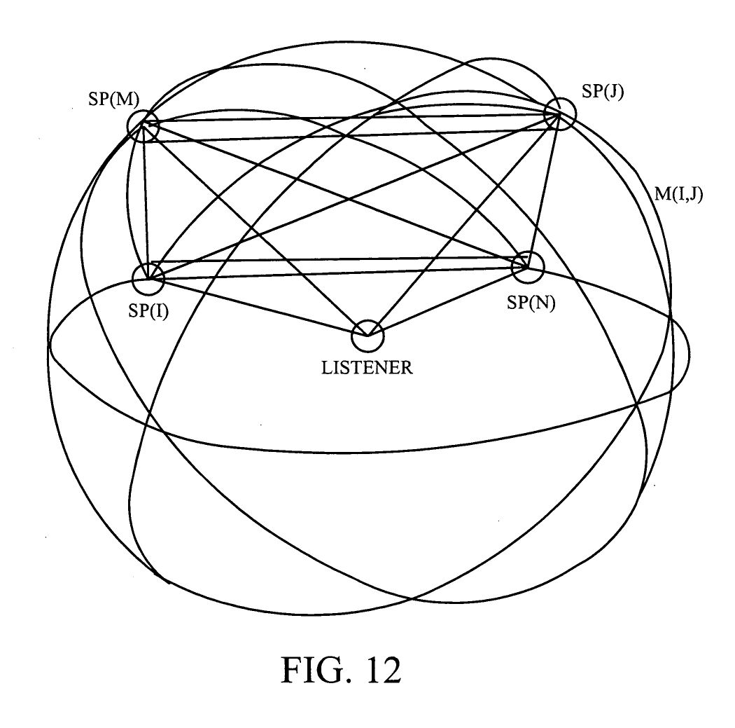

FIG. 12 illustrates an embodiment of the dynamic spatial audio zones system using four fixed position loudspeakers. In this embodiment four loudspeakers are positioned with respect to the display. The display has dimensions MH×NW (height×width). The display may be quantized to display height units (i.e. MH=1). The origin of 3D co-ordinate system can be placed at any arbitrary position. In one embodiment the origin of the co-ordinate system is located at (x,y,z)=(0,0,0) and the left bottom position of the display is at (x,y,z)=(0,0,1) In FIG. 12, the display aspect ratio is

$$\frac{NW}{MH} = \frac{20}{9} .$$

Listener L may be positioned as shown. The circles are in three dimension, centered at Listener (L) and oriented in different 3D planes for each loudspeaker pair Sp(i), Sp(j). Each of these circles is in the plane which is defined by the three points (L, Sp(i), Sp(j)). Each circle is a great circle of the sphere centered at L. It is possible to position a virtual source on a part of the circle using the corresponding loudspeaker pair. This part of the circle is the arc behind the display plane. The arc of the 3D circle is projected onto a 2D line in the plane of the display.

In another embodiment a six loudspeaker system can use four loudspeakers placed substantially near the four corners of the display and two loudspeakers placed substantially near the center of the two vertical (or horizontal) borders of the display.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for presenting audio-visual content for a display comprising:
(a) defining a window associated with a program having associated audio signals on said display;
(b) defining an audio position for said audio signals based upon a position of said window on said display, and a position of at least two speakers associated with said display;
(c) modifying said audio signals based upon said audio position in such a manner that said audio signals appear to originate from said window.

2. The method of claim 1 wherein said method includes two speakers.

3. The method of claim 1 wherein said method includes three speakers.

4. The method of claim 1 wherein said window encompasses a portion of said display.

5. The method of claim 1 further comprising defining multiple windows associated with a program having associated audio signals on said display.

6. The method of claim 1 further comprising defining multiple windows associated with multiple programs having associated audio signals on said display.

7. The method of claim 1 wherein said audio position is based upon a virtual source position arc calculation.

8. The method of claim 1 wherein said audio position is based upon a pair of loudspeakers.

9. The method of claim 1 wherein said audio position is based upon a spherical triangle defined by three loudspeakers.

10. The method of claim 8 wherein said audio position is further based upon a virtual source position arc.

11. The method of claim 10 wherein said virtual source position arc is defined with respect to a listener.

12. The method of claim 11 wherein said virtual source position arc is defined with respect to multiple pairs of speakers.

13. The method of claim 12 wherein said virtual source position arc is selected as the closest to said window.

14. The method of claim 13 wherein audio position is further based upon an on display virtual source position determination.

15. The method of claim 14 wherein on display virtual source position is mapped to said virtual source position.

16. The method of claim 15 wherein said origination is further based upon selecting a gain for each of said loudspeakers.
